(19) United States
(12) Patent Application Publication
(10) Pub. No.: US 2006/0139794 A1
(43) Pub. Date: Jun. 29, 2006

(54) Magnetic disk apparatus

(75) Inventor: Yuka Aoyagi, Tachikawa-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/312,439

(22) Filed: Dec. 21, 2005

(30) Foreign Application Priority Data
Dec. 27, 2004 (JP) JP 2004-378144

(51) Int. Cl. G11B 5/012; G11B 17/00

(52) U.S. Cl. 360/97.01

(57) ABSTRACT

A magnetic disk apparatus includes a magnetic recording media having a substrate, a data recording layer formed on one surface of the substrate and including a magnetic recording layer, and a shield layer formed on the other surface of the substrate and including a soft magnetic layer and no magnetic recording layer, and a magnetic head.

### CROSS-REFERENCE TO RELATED APPLICATIONS

This application is based upon and claims the benefit of priority from prior Japanese Patent Application No. 2004-378144, filed Dec. 27, 2004, the entire contents of which are incorporated herein by reference.

### BACKGROUND OF THE INVENTION

1. Field of the Invention

The present invention relates to a magnetic disk apparatus.

2. Description of the Related Art

It is necessary for a magnetic disk apparatus to reduce influence of an external field. In particular, a perpendicular magnetic disk apparatus is very likely to receive an influence of the external field. The reason is as follows. The perpendicular magnetic disk apparatus comprises a perpendicular double-layer media having a soft underlayer and a perpendicular recording layer and a magnetic head (a single-pole head) having a main pole, a return yoke and an exciting coil, and performs recording by making use of magnetic coupling between the magnetic head and the soft underlayer. Because the perpendicular double-layer media has the soft underlayer with high sensitivity to a field on its entire surface, magnetic information recorded in the media may be readily changed by the external field. For example, if the state of the magnetic coupling between the magnetic head and the soft underlayer is changed by the external field, read output would be changed. If a higher external field is applied, the magnetic head may change the magnetic state of the media so that a write error or erase error can occur. If the write error is made in a servo zone, it may cause the worst case that the drive is made inoperable.

Though external fields may be generated from the spindle motor and the voice coil motor inside the magnetic disk apparatus, these external fields can be estimated. Therefore, it is necessary to take effective measures to an unpredictable external field generated due to other reasons than those described above.

Conventionally, for the purpose of improving external field resistance, a magnetic disk apparatus provided with an external field detector and configured to unload the head when the external field is detected has been proposed. However, even if the external field detector is provided, a write error or erase error may be caused before the head begins unloading operation in a case where a high field enough to cause a write error is instantaneously applied.

On the other hand, there has been known a magnetic disk apparatus the chassis of which is provided with a shield so as to reduce the external field applied to the magnetic head and media. However, particularly in magnetic disk apparatuses for mobile appliances, the disk size is progressively reduced from 2.5-inch or 1.8-inch to 1-inch or less in accordance with requirement for reduction in weight. Thus, the measure of providing the chassis with the shield has become unsuitable for the requirement for reduction in weight.

Under the circumstances, it is necessary for the components such as the magnetic head and media to improve external field resistance. Conventionally, there has been known a perpendicular recording media which uses a magnetic material with a low permeability of 50 to 1,000 for the soft underlayer so as to reduce response of magnetization of the soft underlayer to the external field thereby suppressing concentration of magnetic flux of external field onto the main pole so as to improve external field resistance (Jpn. Pat. Appln. KOKAI Publication No. 2000-90424). However, supposing that the external field resistance is to be improved under a condition that a track width of the single-pole head is reduced to about 150 nm in order to improve recording density, it is desired to reduce the permeability of the soft underlayer to 50 or less. Therefore, the technique disclosed in the Jpn. Pat. Appln. KOKAI Publication No. 2000-90424 cannot satisfy both recording density and external field resistance.

### BRIEF SUMMARY OF THE INVENTION

A magnetic disk apparatus according to one aspect of the present invention comprises: a magnetic recording media having a soft underlayer and a perpendicular recording layer; and a magnetic head having a main pole, a return yoke and an exciting coil, wherein a product of a saturation flux density B (T) and a total thickness t (nm) of the soft underlayer and a magnetic write width MWW (nm) of the magnetic head meets the following relationship:
B·t≧−585.4×MWW+136.5 (T·nm).

A magnetic disk apparatus according to another aspect of the present invention comprises: a magnetic recording media having a substrate, a data recording layer formed on one surface of the substrate and including a magnetic recording layer, and a shield layer formed on the other surface of the substrate and including a soft magnetic layer and no magnetic recording layer; and a magnetic head.

### BRIEF DESCRIPTION OF THE SEVERAL VIEWS OF THE DRAWING

FIG. 1 is a cross-sectional view showing a magnetic disk apparatus of a first embodiment;

FIG. 2 is a diagram showing a relationship between an effective thickness B·t of the soft underlayer and overwrite performance OW for the magnetic disk apparatus according to the first embodiment;

FIG. 3 is a diagram showing a relationship between overwrite performance OW and ΔBER for the magnetic disk apparatus according to the first embodiment;

FIG. 4 is a diagram showing a relationship between a magnetic write width MWW and an effective thickness B·t allowing to ensure overwrite performance OW of 35 dB or more for the magnetic disk apparatus according to the first embodiment;

FIG. 5 is a diagram showing a relationship between a bias field Hb and a permissible external field for the magnetic disk apparatus according to the first embodiment;

FIG. 6 is a cross-sectional view showing a magnetic disk apparatus according to a second embodiment;

FIG. 7 is a diagram showing permissible external fields for the magnetic disk apparatus according to the second embodiment and for the magnetic disk apparatus according to a reference example;

FIG. 8 is a diagram showing a relationship between an effective thickness B·t of the soft magnetic layer included in the shield layer and a permissible external field for the magnetic disk apparatus according to the second embodiment; and

FIG. 9 is a cross-sectional view of a longitudinal recording media according to a second embodiment.

### DETAILED DESCRIPTION OF THE INVENTION

Embodiments of the present invention will be described below with reference to the accompanied drawings.

### First embodiment

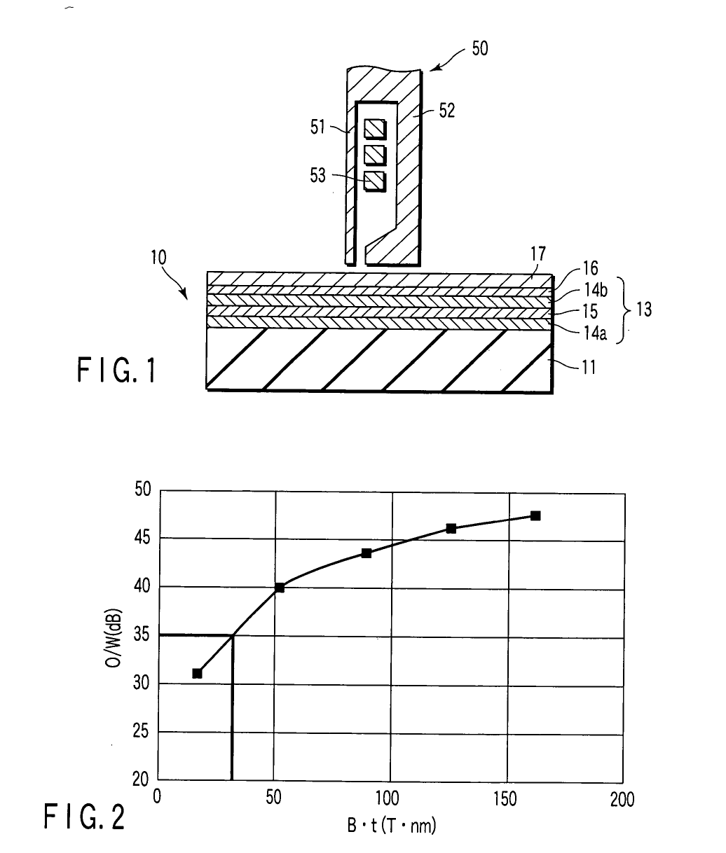

FIG. 1 is a cross-sectional view showing a magnetic disk apparatus according to the present embodiment. The magnetic disk apparatus comprises the magnetic recording media (the perpendicular double-layer media) 10 and the magnetic head 50. The magnetic recording media 10 has a structure in which the soft underlayer 13 (including the soft magnetic layer 14a, the non-magnetic layer 15, and the soft magnetic layer 14b), the intermediate non-magnetic layer 16 and the perpendicular recording layer 17 are stacked on the non-magnetic substrate 11. The magnetic head 50 is a so-called single-pole head and comprises the main pole 51, the return yoke 52 and the exciting coil 53.

The soft magnetic layers 14a, 14b included in the soft underlayer 13 are antiferromagnetically coupled through the non-magnetic layer 15. Examples of the materials for the soft magnetic layers 14a, 14b include soft magnetic materials with a high permeability, for example, CoZrNb alloy, FeTaC alloy, FeZrN alloy, FeSi alloy, FeAl alloy, FeNi alloy such as permalloy, FeCo alloy such as permendur, FeCoNi alloy such as perminvar, NiCo alloy, sendust, MnZn-based ferrite, MgMn-based ferrite, MgZn-based ferrite, FeAlGa, FeCuNbSiB, FeGaGe, FeGeSi, FeSiC, FeZrB, FeZrBCu, CoFeSiB, CoTi, and CoZrTa. An example of the material for the non-magnetic layer 15 includes, for example, Ru. The total thickness t of the soft underlayer 13 (i.e, the total thickness of the soft magnetic layers 14a, 14b) is preferably 10 nm or more, and more preferably between 20 nm and 200 nm. It should be noted that the soft underlayer may comprise three or more soft magnetic layers.

Examples of the materials for the perpendicular recording layer 17 include, for example, CoCr, CoPt, CoPtB, and CoPtCrB. A multilayered film including a film of at least one element selected from Pt, Pd, Rh and Ru and a Co film may be used for the perpendicular recording layer 17. The multilayered film may be formed of CoCr/PtCr, CoB/PdB or CoO/RhO each of which is prepared by adding Cr, B or O to each film of the aforementioned multilayered film.

The perpendicular magnetic disk apparatus comprising the perpendicular double-layer media and the single-pole head performs recording by making use of a flux passing the main pole 51, the soft underlayer 13 and the return yoke 52. It is important to stabilize the magnetization of the soft magnetic layer for ensuring a good signal quality.

The present inventor has paid attention to a relationship among a product (B·t) of a saturation flux density B[T] and a total physical thickness t[nm], which is an effective thickness of the soft underlayer, overwrite performance (OW), and degradation in a bit error rate (ΔBER) due to an external field.

The overwrite performance (OW) relates to recording quality. It is more difficult to write low-frequency signals compared to high-frequency signals in perpendicular magnetic recording. Thus, the overwrite performance (OW) is indicated by a value defined as a ratio (in dB) between a voltage amplitude of the high-frequency signals which is measured before overwrite and a voltage amplitude of the high-frequency signals left without being erased which is measured after overwrite with the low-frequency signals.

FIG. 2 shows a relationship between the effective thickness B·t and the overwrite performance (OW) when using a head with a magnetic write width (MWW) of 180 nm. FIG. 3 shows a relationship between the overwrite performance (OW) and ΔBER.

FIG. 3 shows that dispersion of ΔBER in the region where the overwrite performance (OW) is 35 dB or more is caused by noise in the head and media. Thus, it is believed that sufficient overwrite is performed in the particular region. On the other hand, when the overwrite performance (OW) is 35 dB or less, ΔBER is degraded due to insufficient overwrite. Consequently, it is necessary to ensure 35 dB or more of overwrite performance (OW) for improving external field resistance. FIG. 2 shows that it is necessary to set the value of B·t to 30 [T·nm] or more in order to ensure 35 dB or more of overwrite performance (OW).

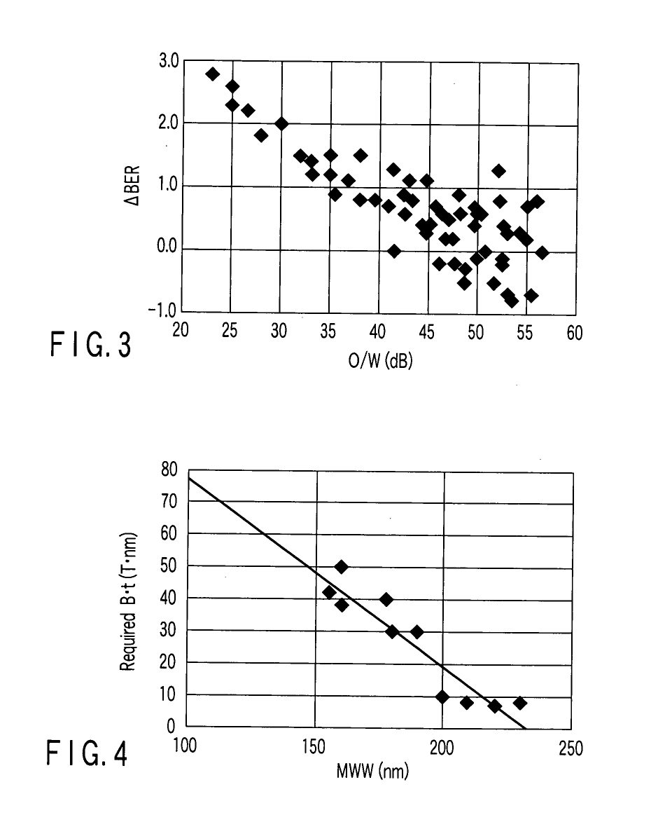

The overwrite performance (OW) also varies depending on the magnetic write width (MWW). That is, when the MWW is reduced, the recording field strength from the head would be lowered and the overwrite performance (OW) would be degraded. Therefore, it is necessary to increase the effective thickness (B·t) in this case. FIG. 4 shows a relationship between the magnetic write width (MWW) and the required effective thickness (B·t) for ensuring 35 dB or more of overwrite performance (OW). It is the region over the straight line in FIG. 4 that high external resistance is obtained. Therefore, the effective thickness B·t (T·nm) and the magnetic write width MWW (nm) should meet the relationship expressed by the following formula:
B·t≧−585.4×MWW+136.5.

The total thickness t of the soft underlayer is preferably smaller than approximately 200 nm, which is a typical value in conventional media, and more preferably 150 nm or less. Thus, an upper limit of the effective thickness B·t is expressed as 200·B (T·nm).

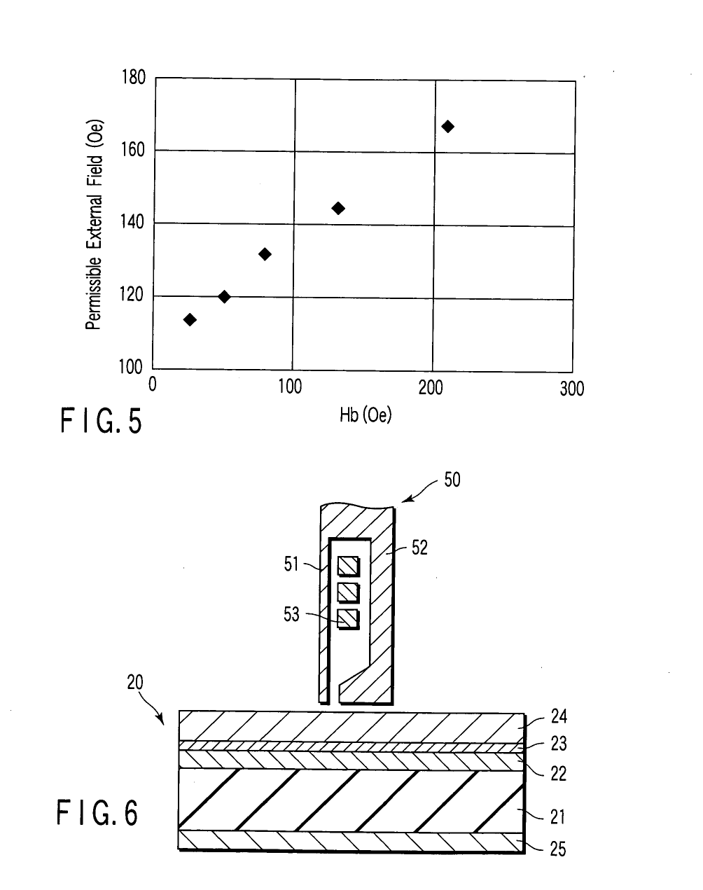

Next, FIG. 5 shows a relationship between the bias field Hb corresponding to the strength of the antiferromagnetic coupling in the soft magnetic layer and the permissible external field. Here, the permissible external field is expressed as a maximum field where ΔBER is left unchanged. The reason is that, if the ΔBER is not changed, it can be judged that there is no influence of the external field as a whole.

It is found from FIG. 5 that the external field resistance can be improved largely with increasing raising the bias field. Roughly speaking, if the bias field is increased by about 50 Oe, the permissible external field can be improved by about 20 Oe. An approach for increasing the bias field is to reduce the total thickness t of the soft underlayer 13. On the other hand, if the effective thickness (B·t) of the soft underlayer is excessively decreased, the overwrite performance (OW) would be deteriorated. Therefore, it is preferable to set the thickness of the soft underlayer 13 to a minimum thickness allowing to ensure 35 dB or more of overwrite performance (OW).

### Second Embodiment

In order to improve the recording density of the magnetic disk apparatus, improvement of the track density is unavoidable. Thus, it is believed that the track width continues to be reduced. However, if the track width is reduced, the field strength from the tip end of the single-pole head is weakened, which would possibly degrade the overwrite performance (OW). According to the present embodiment, a media capable of improving external field resistance with the overwrite performance (OW) maintained without decreasing the effective thickness B·t of the soft underlayer will be explained.

FIG. 6 is a cross-sectional view showing a magnetic disk apparatus according to the present embodiment. The magnetic disk apparatus comprises the magnetic recording media (a perpendicular double-layer media) 20 and the magnetic head 50. In the magnetic recording media 20, the soft underlayer 22, the intermediate non-magnetic layer 23 and the perpendicular recording layer 24 are stacked on one surface of the non-magnetic substrate 21, which surface is used as the data recording layer. On the other hand, the soft magnetic layer 25 is formed on the other surface of the non-magnetic substrate 21 but no perpendicular recording layer is formed thereon, which surface is used as the shield layer. The magnetic head (the single-pole head) 50 comprises the main pole 51, the return yoke 52 and the exciting coil 53.

FIG. 7 shows the permissible external fields of the magnetic disk apparatus according to the second embodiment shown in FIG. 6 and the magnetic disk apparatus (the reference example) having a media in which the stack of the soft underlayer, the intermediate non-magnetic layer and the perpendicular recording layer are formed on both surfaces of the non-magnetic substrate. As shown in the drawing, the second embodiment having the media one surface of which is used as the shield layer exhibits higher external field resistance than the reference example having the media provided with no shield layer.

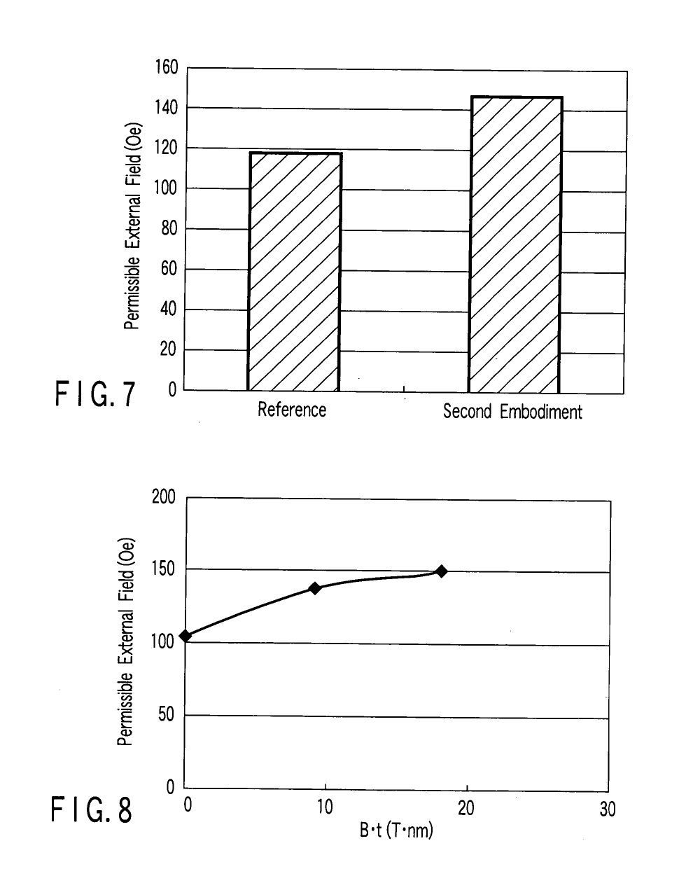

FIG. 8 shows the relationship between the effective thickness (B·t) of the soft magnetic layer 25 included in the shield layer and the permissible external field. It is found from FIG. 8 that the greater B·t is, the higher the permissible external field resistance becomes. Also, it is found that when the B·t of the soft magnetic layer 25 is 10 [T·nm] or more, the permissible external field is improved by 30 Oe or more compared to the case where no soft magnetic layer 25 is provided. Further, because the data recording layer and the shield layer are formed on different surfaces of the substrate 21, respectively, the shield layer never affects the recording characteristics of the data recording layer. Thus, if the B·t of the soft magnetic layer 25 is 10 [T·nm] or more, the external field resistance can be improved without degrading the recording characteristics.

In particular, when the present embodiment is applied to the magnetic disk apparatus of 1.8-inch or less, which is required to reduce the weight for mobile application, the external field resistance can be improved by the media in itself without changing the total weight of the apparatus, providing an effective measure against external field.

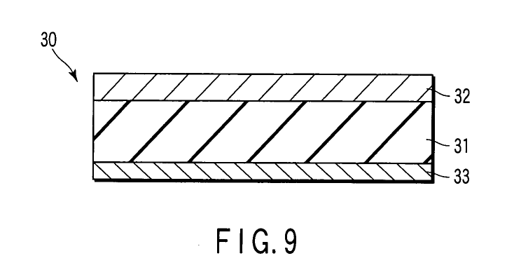

It should be noted that the present embodiment can be applied to not only the perpendicular magnetic disk apparatus but also the longitudinal magnetic disk apparatus. FIG. 9 shows a cross-sectional view of the longitudinal magnetic recording media to which the present embodiment is applied. In the magnetic recording media 30, the longitudinal recording layer 32 is formed on one surface of the non-magnetic substrate 31, which surface is used as a data recording layer. The soft magnetic layer 33 is formed on the other surface of the non-magnetic substrate 31 but the recording layer is not formed, which surface is used as the shield layer. A ring head may be used as the magnetic head for the magnetic recording media 30.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic disk apparatus comprising:
a magnetic recording media having a soft underlayer and a perpendicular recording layer; and
a magnetic head having a main pole, a return yoke and an exciting coil,
wherein a product of a saturation flux density B (T) and a total thickness t (nm) of the soft underlayer and a magnetic write width MWW (nm) of the magnetic head meets the following relationship:
B·t≧−585.4×MWW+136.5 (T·nm).

2. The apparatus according to claim 1, wherein the total thickness t (nm) of the soft underlayer is 200 nm or less.

3. The apparatus according to claim 1, wherein the magnetic write width MWW (nm) of the magnetic head is 200 nm or less.

4. A magnetic disk apparatus comprising:
a magnetic recording media having a substrate, a data recording layer formed on one surface of the substrate and including a magnetic recording layer, and a shield layer formed on the other surface of the substrate and including a soft magnetic layer and no magnetic recording layer; and
a magnetic head.

5. The apparatus according to claim 4, wherein a product of a saturation flux density B (T) and a total thickness t (nm) of the soft magnetic layer included in the shield layer of the magnetic recording media is 10 (T·nm) or more.

6. The apparatus according to claim 4, wherein the data recording layer of the magnetic recording media includes a soft underlayer and a perpendicular recording layer.

7. The apparatus according to claim 4, wherein the data recording layer of the magnetic recording media includes a longitudinal recording layer.
